(19) United States
(12) Patent Application Publication
(10) Pub. No.: US 2006/0120844 A1
(43) Pub. Date: Jun. 8, 2006

(54) Apparatus for pneumatic operation of transport container conveyor

(75) Inventors: David F. Rivers, Wallingford, CT (US); Russell McRoberts, Bremerton, WA (US); Celio J. Gomes, York, ME (US)

Correspondence Address: O'SHEA, GETZ & KOSAKOWSKI, P.C., 1500 MAIN ST., SUITE 912, SPRINGFIELD, MA, 01115, US

(73) Assignee: Patriot Lift Co., LLC, York, ME (US)

(21) Appl. No.: 11/001,934

(22) Filed: Dec. 2, 2004

(51) Int. Cl. B60P 1/00

(52) U.S. Cl. 414/528

(57) ABSTRACT

An apparatus for conveying material from a transport container having a discharge opening is provided. The apparatus includes a conveyor belt, a drive mechanism and a pneumatic motor. The drive mechanism is coupled to the conveyor belt and configured to allow movement of the conveyor belt. The pneumatic motor is coupled to the drive mechanism and is adapted to power the drive mechanism so that the conveyor belt moves in a first direction. A kit for retrofitting a motor assembly of a conveyor assembly mounted on a transport container, a trailer for transporting material, and a system for transporting material are also provided.

### BACKGROUND OF THE INVENTION

1. Field of the Invention

The present invention relates to conveyors in general, and in particular to apparatus for automatic operation of the conveyor systems used on transport containers, such as trailers or railroad cars.

2. Background

The use of trucks, tractor-trailers, railroad cars, etc. for transporting palletized or containerized materials and bulk particulate commodities is well known. Commonly, both flat-bottom and hopper containers may be provided with self-unloading conveyors (or movable floors) for cargo handling. These self-unloading conveyors are typically powered by hydraulic motors.

U.S. Pat. No. 6,220,810 to Wilkerson discloses conveyor assembly including a chain driven conveyor belt. The conveyor assembly is incorporated in the floor of a trailer having sloped-side walls for transporting bulk flow articles such as potatoes. A motor, externally mounted on the trailer, powers the chain driven conveyor belt of the conveyor assembly. The preferred motor is hydraulic, although other drive means, such as electric, gas, or power take-off, are mentioned.

U.S. Pat. No. 6,200,082 to Molenaar et al. discloses a conveyor assembly including a rolling floor for a truck or trailer box for loading and unloading objects. The rolling floor uses a continuous one-piece belt, supported by rollers to reduce friction, which is driven by a wrap-style hydraulic driven traction wheel positioned under the trailer.

U.S. Pat. No. 5,118,244 to Cook discloses a flat-bottomed load hauling box capable of self-unloading bulk particulate and chunk material. A conveyor assembly including an endless belt is looped around a rigid floor plate and around a driven roller at the rear of the hauling box and an idler roller at the front of the hauling box. The driven roller of the endless belt is driven in a stepwise manner by a hydraulically powered motor to produce a jerky motion that loosens the particulate material for more even outflow. The hydraulically powered motor is mounted to a side rail located below the box floor.

U.S. Pat. No. 4,518,303 to Moser discloses a conveyor assembly including a movable floor for a flat-bottom trailer for self-unloading of palletized, containerized and bulk materials. The movable floor is comprised of a series of side-by-side floor plates that are interconnected by hinge pins. Any conventional motor and speed reduction unit may be coupled to a drive shaft and sprocket assembly for driving the movable floor. In particular, an hydraulic motor is shown externally mounted on the trailer.

Typically, hydraulic motors and their components are bulky and heavy. Further, hydraulic motors are not environmentally friendly, operating with potentially harmful hydraulic fluids. Even further, pressurized supplies of hydraulic fluid for operating the hydraulic motors are typically not transported with the transport container, thus limiting the operation of hydraulically powered conveyor systems to stations having such a supply.

What is needed is an apparatus that reduces much of the weight associated with hydraulically powered conveyor systems and that is environmentally friendly. Moreover, with respect to tractor-trailers, what is needed is an apparatus that is powered from existing pneumatic systems carried by the tractor. Additionally, there is a need to retrofit existing transport containers constructed with hydraulically powered conveyor systems with pneumatically powered conveyor systems, where such retrofit is conducted with minimal reconstruction or replacement of the components of the existing conveyor systems.

### DISCLOSURE OF THE INVENTION

According to the present invention, an apparatus for conveying material from a transport container having a discharge opening is provided. The apparatus includes a conveyor belt, a drive mechanism and a pneumatic motor. The drive mechanism is coupled to the conveyor belt and configured to allow movement of the conveyor belt. The pneumatic motor is coupled to the drive mechanism and is adapted to power the drive mechanism so that the conveyor belt moves in a first direction.

In one embodiment, the pneumatic motor can be connected to a pre-existing compressed air supply of a vehicle's emergency brake system. A pneumatic motor avoids the problems associated with hydraulic motors and electrical motors in an outdoor environment.

In another embodiment, a kit for retrofitting a motor assembly of a conveyor assembly mounted on a transport container is provided. The kit includes a gearbox, a pneumatic motor and a controller mechanism. The gearbox has an input shaft and an output shaft. The output shaft is configured to be operatively connected to a drive shaft of the conveyor assembly. The pneumatic motor is coupled to the input shaft of the gearbox and configured to receive a compressed air supply. The controller mechanism is configured to selectively control the pneumatic motor and the gearbox so as to drive the conveyor assembly.

In a further embodiment, a trailer for conveying material is provided. The trailer includes a transport container having a discharge opening and a conveyor belt mounted on the transport container. A drive mechanism is operatively coupled to the conveyor belt and configured to allow movement of the conveyor belt. A pneumatic motor is operatively coupled to the drive mechanism and configured to power the drive mechanism so that the conveyor belt moves in a first direction. The pneumatic motor is configured to receive compressed air. A compressed air control mechanism is operatively coupled to the pneumatic motor. The air control mechanism is configured to be operatively coupled to an air powered emergency brake system of a vehicle.

In another embodiment, a system for conveying material is provided. The system includes a transport container having a discharge opening and a vehicle for transporting the transport container, wherein the vehicle has an air powered emergency brake system. A conveyor belt is mounted on the transport container. A drive mechanism is coupled to the conveyor belt and configured to allow movement of the conveyor belt. A pneumatic motor is coupled to the drive mechanism and configured to power the drive mechanism so that the conveyor belt moves in a first direction. A compressed air source is operatively coupled to the pneumatic motor to provide an air supply to the pneumatic motor. The compressed air source is the air powered emergency brake system of the vehicle.

In addition to providing an improvement to existing transport container conveyer assemblies relying on hydraulic drive motors, the present invention provides several advantages over existing systems. For example, the present invention has the advantage of providing such improvement to existing transport container conveyor assemblies by retrofitting the present invention to the existing components of transport container conveyor assemblies. This retrofitting may be accomplished with minimal reconstruction, redesign or replacement of components of the existing conveyor systems. The present invention also has the advantage of using available sources of air available to vehicles to operate the pneumatic motor to power the conveyor assemblies.

These and other objects, features and advantages of the present invention will become apparent in light of the drawings and detailed description of various embodiments of the present invention provided below.

### BRIEF DESCRIPTION OF THE DRAWINGS

FIG. 1 is a diagram of a perspective view of a first embodiment of the present invention as adapted for use with a tractor-trailer and a flat-bottom transport container;

FIG. 2 is a rear view taken along line 2-2 of FIG. 1;

FIG. 3 is a partial schematic diagram of an embodiment of a compressed air supply system, controller, motor and gearbox of the present invention;

FIG. 4 is a partial schematic diagram of a coupler located between the gearbox and the pneumatic motor that may be used in an embodiment of the present invention; and

FIG. 5 is a diagram of a perspective view of another embodiment of the present invention as adapted for use with a hopper-type transport container.

### DETAILED DESCRIPTION OF EMBODIMENTS OF THE PRESENT INVENTION

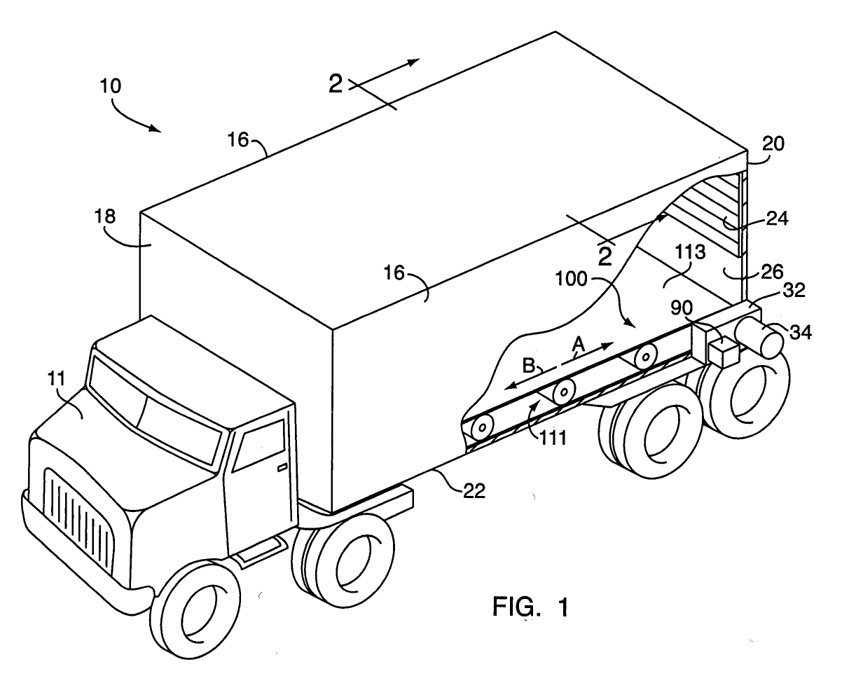

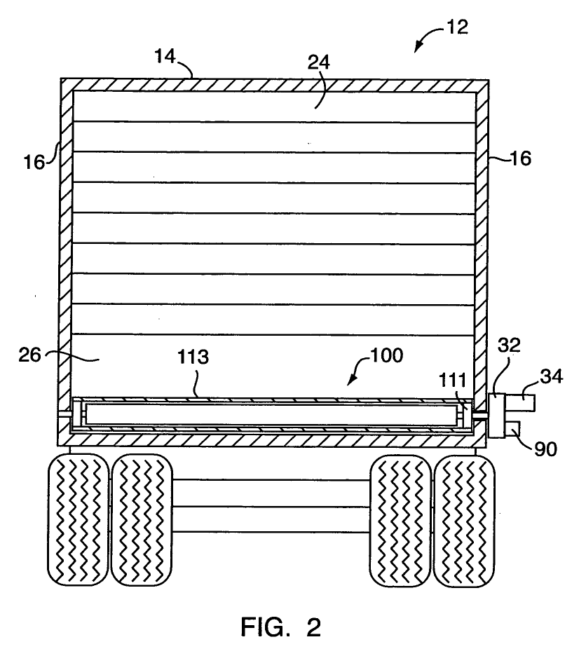

Referring to FIGS. 1-2, one embodiment of the present invention includes a gearbox, a pneumatic motor and a controller operatively connected to a conveyor assembly of a transport container having a discharge opening.

As shown in FIG. 1, a tractor-trailer having a transport container is generally designated by reference numeral 10. Tractor-trailer 10 includes a motorized vehicle 11 and a flat-bottom transport container 12 for storing and transporting material or goods. While a tractor-trailer flat-bottom transport container is shown, the present invention has utility on other transport container designs, including, but not limited to, general purpose delivery trucks, hopper-type trailers, flat-bottom and hopper-type railroad cars. As illustrated in FIG. 1, container 12 has a generally rectangular configuration, and includes a top wall 14, generally opposed side walls 16, a front wall 18, a rear wall 20, which is generally opposed to front wall 18, and a floor 22. Rear wall 20 acts as a gate or door 24 movable between a closed position and an opened position and allowing material to pass into or out of container 12 through a discharge opening 26.

A conveyer assembly 100 is mounted on transport container 12. As shown in FIGS. 1 and 2, conveyer assembly 100 includes a drive mechanism 111 and a conveyor belt 113. Conveyor assembly 100, as well as drive mechanism 111 and conveyor belt 113, may conform to any conveyor assembly as known in the art, and as such, the design and operation of these conveyor assemblies will not be further described herein.

Regardless of the exact configuration of conveyor assembly, drive mechanism 111 is provided to drive conveyor belt 113 in a first direction A, toward discharge opening 26. In one embodiment, drive mechanism 111 is also configured to drive conveyor belt 113 in a second direction B, away from discharge opening 26.

As shown in FIGS. 1 and 2, a gearbox 32 and a pneumatic motor 34 are mounted on the side of container 12 proximate to an input drive shaft of drive mechanism 111. Gearbox 32 and motor 34 may be mounted inside or outside of transport container 12; furthermore, gearbox 32 and motor 34 may be mounted on the underside of transport container 12 or any other location that allows gearbox 32 and motor 34 to be operatively connected to conveyor assembly 100. The present invention permits and facilitates retrofitting of conveyor assemblies with such pneumatic motors with minimal reconstruction and redesign of the existing conveyor assembly and its components.

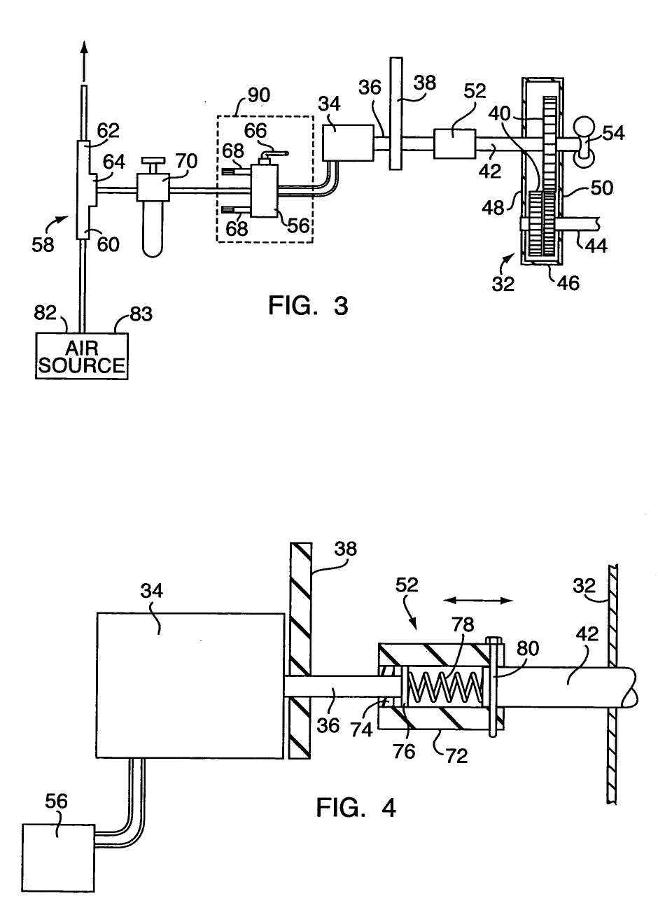

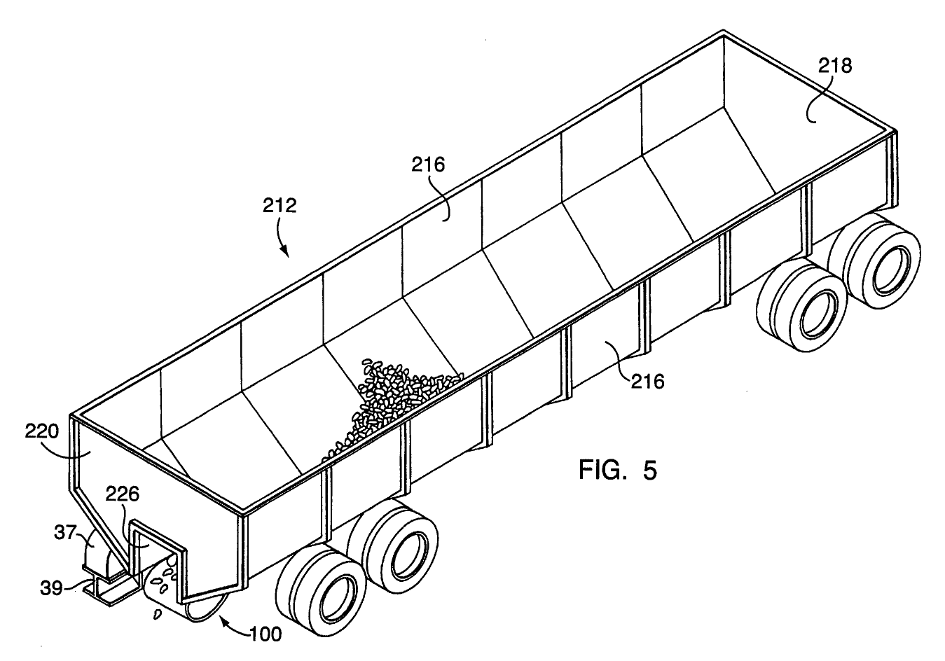

As schematically shown in FIGS. 3 and 4, motor 34 includes an output motor shaft 36 operatively coupled to gearbox 32. For example, a mounting plate 38 can be secured to container 12 for mounting of motor 34 in a location proximate to gearbox 32, although the pneumatic motor may also be mounted directly to the transport container or to the gearbox. Motor 34 is preferably a commercially available pneumatic gear motor that is powered by an external compressed air source. An example of an acceptable pneumatic gear motor is a WADCO pneumatic gear motor model no. 33MA-220S1 produced by WADCO, a division of Ingersoll-Rand. Preferably, the motor is a vane-type rotary driven motor having a gear reduction assembly with an 80-100 to 1 gear reduction ratio.

Gearbox 32 includes a plurality of gears 40, an input shaft 42, an output shaft 44, and a housing 46 having a first side 48 and a second side 50. As shown in FIG. 3, input shaft 42 and output shaft 44 extend out from the opposite first and second sides 48 and 50, respectively, of housing 46. On first side 48 of housing 46, input shaft 42 is coupled to motor shaft 36 of motor 34. Preferably, a hardened socket coupler 52 receives and is connected to both input shaft 42 and motor shaft 36 (e.g., a through pin 80 or the like, as shown in FIG. 4, may be used to connect input shaft 42 to coupler 52). Input shaft 42 and output shaft 44 communicate with gears 40 in gearbox 32. Gears 40 are mounted within housing 46 in an arrangement that creates mechanical advantage for input shaft 42 relative to output shaft 44—i.e., force transmitted to input shaft 42 is multiplied through gears 40 to create a greater force available at output shaft 44. The arrangement of gears 40 and the amount of mechanical advantage created by gears 40 is variable to the application at hand. In one embodiment, gearbox 32 includes a planetary gear assembly.

On second side 50 of housing 46, output shaft 44 is coupled to drive mechanism 111, for example, via a drive shaft and a universal joint (not shown).

Pneumatic motor 34 is operable with compressed air provided from an air source generally designated in FIG. 3 by reference numeral 82. Air source 82 may be a separate cylinder attached to transport container 12, or in another embodiment, an existing air supply from an air brake system of tractor trailer 10 or other vehicle. In particular, compressed air may be supplied to pneumatic motor 34 from an air powered emergency brake system 83 of the vehicle. Air powered emergency brake systems are known in the art, and as such, the design and operation of these brake systems will not be further described herein.

A controller mechanism 90 is provided to control the flow of compressed air to pneumatic motor 34. In one embodiment, controller mechanism 90 includes a valve 56 operatively coupled to a vehicle's emergency brake air supply to drive motor 34 and to provide the power to turn the gearbox shafts 42 and 44. Preferably a connector 58 is provided on the emergency brake line so that the air supply can be directed to motor 34. As shown in FIG. 3, connector 58 is a tee-connector. Connector 58 has an input port 60 to receive compressed air from air source 82, a first output port 62 to direct the air supply to the emergency brake system of the vehicle, and a second output port 64 to direct the air supply to motor 34. Controller valve 56 may be connected to the second output port 64 to control the air supply to motor 34.

Preferably, valve 56 acts as an air shutoff valve that controls the direction and amount of air motor 34 receives. In one mode of operating the present invention, air shutoff valve 56 will only provide airflow to motor 34 if valve 56 is manually opened and retained in the open position (e.g., by manually moving a spring-biased lever 66 as shown in FIG. 3). That is, air will be directed to motor 34 if the operator moves and holds lever 66. Once lever 66 is returned to the “off” position, the air supply to the motor 34 will be shut off. If the lever 66 is released, valve 56 will automatically shut off. This prevents the operator from leaving the air supply connected to motor 34 and not the emergency brake line, even when the operation of the conveyor assembly 100 is completed. This ensures that a sufficient air supply is provided to the emergency brake line when the vehicle is being driven.

In one embodiment, valve 56 is a three-position valve that includes an “off” position, a first supply position (“open”), and a second supply position (“close”). As noted above, valve 56 may be spring-biased to the “off” position. Lever 66 enables the operator to move the valve between the “off” position and either of the first or second supply positions. Valve 56 is connected to motor 34 such that air passing through valve 56 when in the first supply position causes motor 34 to rotate in a first direction (e.g., clockwise) associated with moving conveyor mechanism 100 in a first direction for unloading transport container 12. Likewise, valve 56 is connected to motor 34 such that air passing through valve 56 when in the second supply position causes motor 34 to rotate in a second direction (e.g., counterclockwise) associated with moving conveyor mechanism 100 in a second direction for loading transport container 12. The specific directions identified herein are used for illustration purposes only, and the present invention is not intended to prescribe specific directions for specific actions (i.e., clockwise may be used to move the conveyor mechanism in the second direction for loading the transport container). Valve 56 employs one or more air escape ports that may utilize mufflers 68 to allow unneeded or excess air to escape. Pneumatic control valves are known in the art and the operation thereof need not be discussed further herein. Preferably, the valves used in the operation described above are commercially available valves.

In alternative embodiments, the valve 56 may be a power-assisted type control valve that utilizes one or more solenoids, for example to actuate the valve to the first or second positions. Such a power-assisted valve may be configured so that the user operates the valve in proximity of the valve, or at a position remote from the valve (e.g., from the cab of a tractor trailer). Even with such alternative valve designs, however, the valve is preferably biased towards the “off” position when not in use for the safety reasons identified above.

In another embodiment, an automatic lubrication unit 70 (e.g., an oil mist lubricator) is provided upstream of pneumatic motor 34, and more preferably upstream of motor 34 and valve 56. The lubrication unit 70 treats the air with a fine oil mist so that valve 56 and motor 34 are lubricated and so that they can operate efficiently. Automatic lubrication units are known in the art and will not, therefore, be further described herein.

The coupler 52 between the input shaft 42 of gearbox 32 and motor shaft 36 accommodates axial movement of input shaft 42, for example, if gearbox 32 has the capability to shift gears. Alternatively, input shaft 42 on second side 50 of gearbox housing 46 can be provided with a knob 54. The gearbox 32 can be changed from a high gear to a low gear, or vice versa, by axially moving knob 54 and input shaft 42 inward or outward, depending on the initial position of the input shaft and the desired gear. Moving input shaft 42 axially to change the gear causes input shaft 42 extending from first side 48 of gearbox housing 46 through to second side 50 of gearbox housing 46 to correspondingly move, which movement coupler 52 is adapted to accommodate.

An example of a type of coupler for use in the present invention is diagrammatically shown in FIG. 4. There, coupler 52 includes a housing 72, a motor shaft flange 74, a plate 76, and a spring 78. The housing 72 has a gearbox end and a motor end receiving and accommodating input shaft 42 and motor shaft 36 respectively. The input shaft 42 and motor shaft 36 may be connected to housing 72 in a variety of known ways. As shown, for example, in FIG. 4, input shaft 42 is connected to housing 72 using through pin 80.

The motor shaft flange 74 is disposed adjacent the motor end of coupler housing 72 and includes an aperture for slidably receiving motor shaft 36. Input shaft 42 is received within and fixed to the gearbox end of housing 72. Spring 78 and plate 76 are disposed within housing 72 with spring 78 disposed towards input shaft 42 and plate 76 disposed towards motor shaft 36 and retained by motor shaft flange 74.

When gearbox 32 is in high gear, input shaft 42 is in a first axial position. When knob 54 and attached input shaft 42 are pushed inward to change to the low gear, input shaft 42 moves axially against the pressure of spring 78 a distance sufficient to engage the low gear. Coupler 52 moves axially along motor shaft 36, compressing spring 78. When the operator moves knob 54 and input shaft 42 back into the high gear, spring 78 acts against input shaft 42 and returns input shaft 42 to the first axial position associated with the high gear.

As shown in FIG. 5, the conveyor assembly 100 may be mounted on a hopper-type transport container 212 adapted to carry particulate matter. Transport container 212 includes at least partially-sloped side walls 216, a front wall 218, a rear wall 220 and a floor (not shown). In this embodiment, discharge opening 226 may be located at the intersection of rear wall 220 and the floor of container 212. In this embodiment, pneumatic motor 34, gearbox 32 and controller 90 are mounted within housing 37, which is mounted on a side rail 39.

In the operation of one embodiment of the present invention, for example, the embodiment shown in FIGS. 1-3, the operator parks the vehicle, for instance, tractor trailer 10, in a discharge location and selects a desired gear for gearbox 32. The operator then moves control valve 56 into the supply position designated “unload” causing belt 113 of conveyor assembly 100 to move towards discharge opening 26. In the “unload” position, the compressed air powers pneumatic motor 34, which drives gearbox 32 and attached drive mechanism 111, which in turn operates mechanical means communicating with conveyor belt 113. When the operator wishes to stop movement of conveyor belt 113 towards discharge opening 26, the operator releases valve lever 66 and valve 56 automatically returns to the “off” position. When the operator elects to drive conveyor belt 113 away from discharge opening 26 (e.g., when loading palletized or containerized goods into transport container 12), valve 56 is moved into the supply position designated “load.” In the “load” position, the compressed air powers motor 34, and therefore attached gearbox 32 and drive mechanism 111 are operated in the opposite rotational direction as assumed for the “unload” direction. As a result, the movement of the mechanical means communicating with conveyor belt 113 is reversed and conveyor belt 113 moves in a direction away from discharge opening 26. Once the desired position of conveyor belt 113 is reached, the operator releases valve lever 66 and valve 56 automatically returns to the “off” position.

An embodiment of the present invention apparatus for conveying material from a transport container is a retrofit kit for replacing a hydraulic (or electrical) motor and gearbox systems with a pneumatic motor and gearbox system. The retrofit kit includes a pneumatic motor 34, a controller mechanism 56 and a gearbox 32. Motor 34 and controller mechanism 90 are connected to an air source 82 as described above. Gearbox 32 is coupled with the existing drive mechanism, with motor 34 being coupled with the gearbox 32 as described above. In addition, motor 34 and controller mechanism 90 are connected to air source 82 as described above. In both instances, the operation of the retrofitted system is the same as or similar to that described above.

Although the present invention has been described with respect to improvements in conveyor systems for general cargo-type flat-bottom beds or trailers, the claimed invention may be easily adapted for used with any palletized, containerized or bulk material transporters. See, for example, FIG. 5. Further, although this invention has been shown and described with respect to the detailed embodiments thereof, it will be understood by those skilled in the art that various changes in form and detail thereof may be made without departing from the spirit and scope of the invention.

What is claimed is:

1. An apparatus for conveying material from a transport container having a discharge opening, the apparatus comprising:
a conveyor belt;
a drive mechanism coupled to said conveyor belt and configured to allow movement of said conveyor belt; and
a pneumatic motor coupled to said drive mechanism and adapted to power the drive mechanism so that the conveyor belt moves in a first direction.

2. The apparatus of claim 1, further comprising:
a compressed air source adapted to provide an air supply to said pneumatic motor.

3. The apparatus of claim 2, wherein the transport container is coupled to a vehicle and said compressed air source is an air brake system of said vehicle.

4. The apparatus of claim 3, wherein said compressed air source is an air powered emergency brake system of said vehicle.

5. The apparatus of claim 2, further comprising:
a controller mechanism configured to selectively control said pneumatic motor,
wherein said controller mechanism includes an airflow valve configured to control the amount of the air supplied to said motor.

6. The apparatus of claim 5, wherein said airflow valve includes:
a first operating position providing an airflow to said motor to rotate said motor in said first direction, said first operating position being associated with said conveyor belt moving towards said discharge opening;
a second operating position providing an airflow to said motor to rotate said motor in a second direction, said second operating position being associated with said conveyor belt moving away from said discharge opening; and
a third operating position restricting airflow from said motor.

7. The apparatus of claim 6, wherein said airflow valve is biased towards said third operating position.

8. The apparatus of claim 2, further comprising:
a lubricator unit configured to provide a lubricant mist into said air supply supplied to said motor.

9. The apparatus of claim 1, further comprising:
a gearbox having a plurality of gears, an input shaft and an output shaft, said gearbox configured to shift gears,
wherein said pneumatic motor includes a motor shaft that is coupled to said input shaft of said gearbox, and said drive mechanism is coupled to said output shaft of said gearbox.

10. The apparatus of claim 9, wherein said gearbox includes a planetary gear assembly.

11. The apparatus of claim 10, further comprising:
a coupler configured to accommodate said input shaft of said gearbox and said motor shaft of said pneumatic motor,
wherein said coupler is configured to transfer a rotational force of said motor shaft to said input shaft.

12. The apparatus of claim 11, wherein said coupler is configured to permit axial movement of said input shaft to effect shifting of said gearbox gears.

13. An apparatus for operating a conveyor assembly of a transport container, wherein the conveyor assembly includes a drive mechanism operable to move a conveyor belt in a first direction, the apparatus comprising:
a gearbox having an input shaft and an output shaft, said output shaft being operatively connected to the drive mechanism of the conveyor assembly;
a pneumatic motor coupled to said input shaft of said gearbox;
a controller mechanism configured to selectively control said pneumatic motor and said gearbox to operate the conveyor assembly.

14. The apparatus of claim 13, further comprising:
a source of compressed air to power said pneumatic motor.

15. The apparatus of claim 13,
wherein said source of compressed air is an air powered brake system of a vehicle connected to the transport container; and
further comprising, a connector configured to tap into said air powered brake system.

16. The apparatus of claim 15, wherein said source of compressed air is an air operated emergency brake system.

17. A kit for retrofitting a motor assembly of a conveyor assembly mounted on a transport container, the kit comprising:
a gearbox having an input shaft and an output shaft, said output shaft configured to be operatively connected to a drive shaft of the conveyor assembly;
a pneumatic motor coupled to said input shaft of said gearbox and configured to receive a compressed air supply;
a controller mechanism configured to selectively control said pneumatic motor and said gearbox so as to drive the conveyor assembly.

18. The kit of claim 17, said controller mechanism further comprising:
an air shutoff valve configured to control the amount of said compressed air supplied to said motor; and
a connector configured to tap into an air powered brake system of a vehicle.

19. A kit for retrofitting a motor assembly of a conveyor assembly mounted on a transport container, the kit comprising:
a gearbox having an input shaft and an output shaft, said output shaft configured to be operatively connected to a drive shaft of the conveyor assembly;
a pneumatic motor coupled to said input shaft of said gearbox; and
a controller mechanism operatively coupled to said pneumatic motor, said controller mechanism configured to tap into an air powered emergency brake system.

20. A trailer for conveying material, the trailer comprising:
a transport container having a discharge opening;
a conveyor belt mounted on said transport container;
a drive mechanism operatively coupled to said conveyor belt and configured to allow movement of said conveyor belt;
a pneumatic motor operatively coupled to said drive mechanism and configured to power the drive mechanism so that said conveyor belt moves in a first direction, said pneumatic motor configured to receive compressed air; and
a compressed air control mechanism operatively coupled to said pneumatic motor and configured to be operatively coupled to an air powered emergency brake system of a vehicle.

21. A system for conveying material, the system comprising:
a transport container having a discharge opening;
a vehicle for transporting said transport container, said vehicle having an air powered emergency brake system;
a conveyor belt mounted on said transport container;
a drive mechanism coupled to said conveyor belt and configured to allow movement of said conveyor belt; and
a pneumatic motor coupled to said drive mechanism and configured to power the drive mechanism so that said conveyor belt moves in a first direction;
a compressed air source operatively coupled to said pneumatic motor to provide an air supply to said pneumatic motor, wherein said compressed air source is said air powered emergency brake system of said vehicle.
